(19) United States
(12) Patent Application Publication
(10) Pub. No.: US 2012/0176534 A1
(43) Pub. Date: Jul. 12, 2012

(54) CAMERA MODULE

(75) Inventor: WEN-CHIN TSAI, Tu-Cheng (TW)

(73) Assignee: HON HAI PRECISION INDUSTRY CO., LTD., Tu-Cheng (TW)

(21) Appl. No.: 13/095,872

(22) Filed: Apr. 28, 2011

(30) Foreign Application Priority Data
Jan. 10, 2011 (TW) 100100739

(51) Int. Cl. H04N 5/225

(52) U.S. Cl. 348/374; 348/E05.024

(57) ABSTRACT

A camera module includes a square substrate, an image sensor, and a lens module. The square substrate includes a mounting surface. The mounting surface includes two opposing first sides and two opposing second sides perpendicular to the two first sides. The square substrate includes two first protrusions respectively arranged on the center of the two first sides and two second protrusions respectively arranged on the center of the two second sides. The image sensor is fixed on the mounting surface. The lens module is mounted on the substrate, abutting against the two first protrusions and the two second protrusions and housing the image sensor.

### BACKGROUND

1. Technical Field

The present disclosure relates to camera modules and, particularly, to a camera module with optical axis precisely perpendicular to an image sensor thereof.

2. Description of Related Art

Camera modules generally include a square substrate, an image sensor, and a lens module. The image sensor has an image sensitive surface and is fixed to the substrate such that the image sensitive surface of the image sensor is parallel to the substrate. The lens module has an optical axis and includes a planar end surface that is perpendicular to the optical axis. The lens module is fixed to the substrate such that the end surface contacts the substrate and the image sensor is housed in the lens module. Thus, the optical axis is desirably perpendicular to the image sensitive surface of the image sensor and the image sensitive surface can receive a clear optical image formed by the lens module. The substrate is usually cut from a mother board. As the substrate is square, the corners of the substrate are easily bugled up after being cut. Therefore, it is not uncommon that a corner of the substrate undesirably bends toward the lens module. The lens module will tilt when fixed to the substrate. This will adversely affect the image quality of the camera module.

Therefore, it is desirable to provide a camera module which can overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure.

FIG. 1 is a cross-sectional view of a camera module, in accordance with a first embodiment, the camera module including a substrate.

FIG. 2 is a top view of one embodiment of the substrate.

FIG. 3 is a top view of another embodiment of the substrate.

FIG. 4 is a cross-sectional view of a camera module, according to a second embodiment.

### DETAILED DESCRIPTION

Embodiments of the present disclosure will now be described in detail with reference to the drawings.

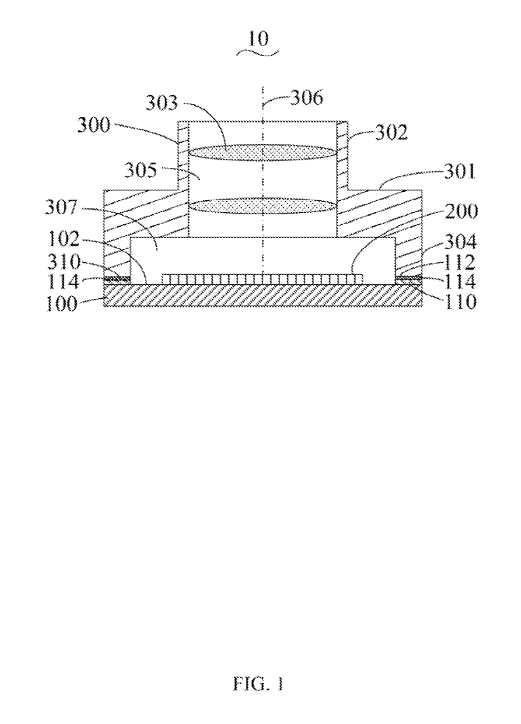

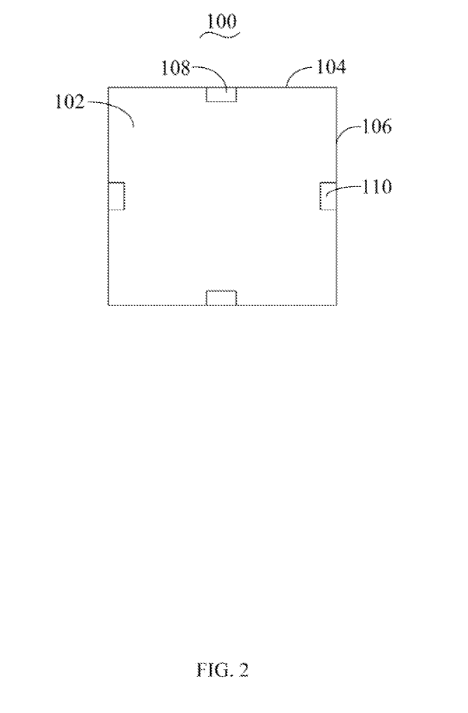

Referring to FIGS. 1 and 2, a camera module 10, according to a first embodiment, includes a square substrate 100, an image sensor 200, and a lens module 300.

One embodiment of the substrate 100 is substantially rectangular and includes a mounting surface 102. The mounting surface 102 includes two opposing first sides 104 and two opposing second sides 106. The two first sides 104 are perpendicular to the two second sides 106. The substrate 100 also includes two first protrusions 108 and two second protrusions 110 bulging up from the mounting surface 102. Each of the two first protrusions 108 is aligned to a corresponding first side 104 and located at the center of the corresponding first side 104. Each of the two second protrusions 110 is aligned to corresponding second side 106 and located at the center of the corresponding second side 106. The two first protrusions 108 and the two second protrusions 110 (hereinafter referred as protrusions) respectively include a planar top surface 112 facing away from the mounting surface 102. The top surfaces 112 are coplanar. The heights (distance from the mounting surface 102 to the top surface 112) can range from 30 micrometers to 500 micrometers. In the present embodiment, the protrusions are all copper foils with a height of about 300 micrometers.

In alternative embodiments, each of the protrusions can include a solder mask 114 on the top surface 112. The solder mask is configured for protecting the protrusions and disabling the electric conductivity of the protrusions.

The lens module 300 defines an optical axis 306. The lens module 300 includes a planar end surface 310 corresponding to the substrate 100 and perpendicular to the optical axis 306. In detail, the lens module 300 includes a lens barrel 301 and a number of lenses 303. The lens barrel 301 includes a cylindrical portion 302 and a square portion 304 opposing the cylindrical portion 302. The cylindrical portion 302 defines a cylindrical room 305 along the optical axis 306. The square portion 304 includes the end surface 310 at an end facing away the cylindrical portion 302. The end surface 310 corresponds to the substrate 100. The square portion 304 defines square room 307 along the optical axis 306 communicating with the cylindrical room 305. The lenses 303 are received in the cylindrical room 305.

In assembly, the image sensor 200 is fixed to the center of the mounting surface 102 such that the image sensor 200 is parallel to the mounting surface 102. The end surface 310 of the lens module 300 is fixed to the substrate 100, abutting against the four top surfaces 112. The image sensor 200 is housed in the square room 307. As such, the optical axis 306 is perpendicular to the image sensor 200.

In case a corner of the substrate 100 bends toward the lens module 300 for less then the height of the protrusions, the lens module 300 can still abut against the protrusions and the bent corner cannot contact the lens module 300. Thus, the optical axis 306 of the lens module 300 is still perpendicular to the image sensor 200. Therefore, the quality of the camera module 10 is improved.

When a corner of the substrate 100 bends more than about 300 micrometers, it usually can be observed and the substrate 100 will be removed. Thus, the protrusions having a height of about 300 micrometers can resolve most of the bending problems that have been discussed above. Of course, the height of the protrusions can be made according to actual need, not limited to the present embodiment.

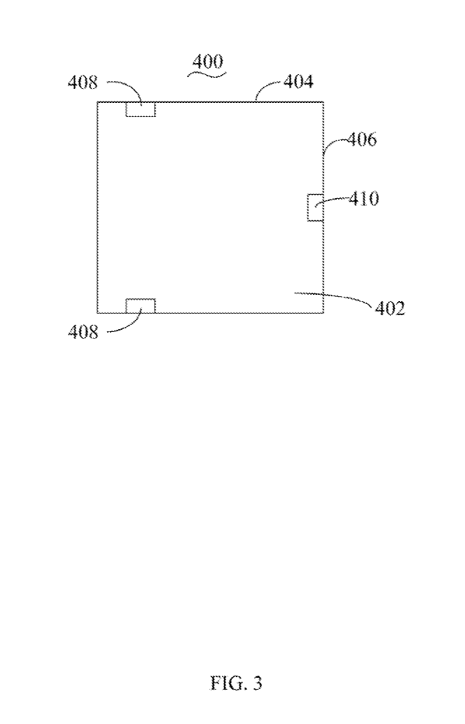

Referring to FIG. 3, another embodiment of a substrate 400 is substantially rectangular and includes a mounting surface 402. The mounting surface 402 can include two first protrusions 408 and a second protrusion 410. The second protrusion 410 is arranged on a center of a second side 406. Each of the two first protrusions 408 is arranged at a corresponding first side 404. The two first protrusions 408 are arranged at a side of a line that is away from the second protrusion 410, where the line connects the centers of the two first sides 404. As such, when a force perpendicular to the mounting surface is added to a side of the lens module that is away from the second protrusion 410, the two first protrusions 408 can firmly hold the lens module.

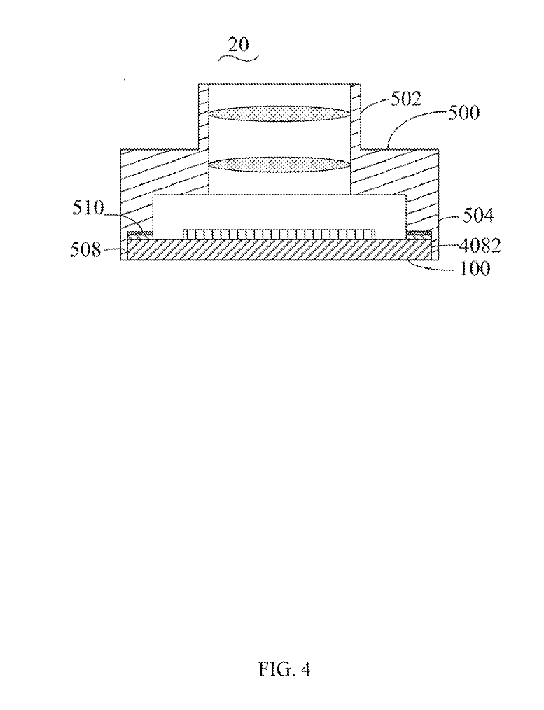

Referring to FIG. 4, a second embodiment of a camera module 20 is similar to the first embodiment of the camera module 10 of FIGS. 1 and 2, except that a lens module 500 includes a cylindrical portion 502 and a square portion 504 connecting to the cylindrical portion 502. The square portion 504 can include a flange 508 protruding from an end surface 510. The flange 408 defines a receiving cavity 4082 corresponding to the substrate 100. As such, the substrate 100 abuts against the end surface 510 and is surrounded by the flange 508. Therefore, the substrate 100 is precisely located.

It will be understood that the above particular embodiments is shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A camera module, comprising:
a square substrate, the substrate comprising:
a mounting surface, the mounting surface comprising two opposing first sides and two opposing second sides, the two first sides being perpendicular to the two second sides;
two first protrusions, each of the two first protrusions being arranged on a corresponding first side and located at the center of the corresponding first side; and
two second protrusions, each of the two second protrusions being arranged on a corresponding second side and located at the center of the corresponding second side, each of the two first protrusions and the two second protrusions comprising a planar top surface facing away the mounting surface, the top surfaces of the two first protrusions and the two second protrusions being coplanar to each other;
an image sensor positioned on the mounting surface and parallel to the mounting surface; and
a lens module defining an optical axis, the lens module comprising an end surface, the end surface being corresponding to the substrate and perpendicular to the optical axis, wherein the lens module is positioned on the substrate, the end surface contacts the top surfaces, and the lens module houses the image sensor.

2. The camera module of claim 1, wherein the two first protrusions and the two second protrusions are all copper foils.

3. The camera module of claim 2, wherein each of the two first protrusions and the two second protrusions comprises a solder mask on the top surface thereof.

4. The camera module of claim 1, wherein the distance from the mounting surface to each of the top surfaces of the two first protrusions and the two second protrusions is in an arrange from 30 micrometers to 500 micrometers.

5. The camera module of claim 1, wherein the distance from the mounting surface to each of the top surfaces of the two first protrusions and the two second protrusions is about 300 micrometers.

6. The camera module of claim 1, wherein the lens module further comprises a flange protruding from the end surface, wherein the square substrate is surrounded by the flange.

7. A camera module, comprising:
a square substrate, the square substrate comprising:
a mounting surface, the mounting surface comprising two opposing first sides and two opposing second sides, the two first sides being perpendicular to the two second sides;
a first protrusion arranged on the center of a first side; and
two second protrusions, each of the two second protrusions being arranged on a corresponding second side and located at a side of a line that is away from the first protrusion, wherein the line connects the centers of the two second sides, each of the first protrusion and the two second protrusions comprises a planar top surface facing away the mounting surface, the top surfaces of the first protrusion and the two second protrusions are coplanar to each other;
an image sensor positioned on the mounting surface and parallel to the mounting surface; and
a lens module defining a optical axis, the lens module comprising an end surface corresponding to the substrate and perpendicular to the optical axis, wherein the lens module is positioned on the substrate, the end surface contacts the top surfaces, and the lens module houses the image sensor.

8. The camera module of claim 7, wherein the first protrusion and the two second protrusions are all copper foils.

9. The camera module of claim 8, wherein each of the first protrusion and the two second protrusions comprises a solder mask on the top surface thereof.

10. The camera module of claim 7, wherein the distance from the mounting surface to each of the top surfaces of the first protrusion and the two second protrusions is in a range from 30 micrometers to 500 micrometers.

11. The camera module of claim 7, wherein the distance from the mounting surface to each of the top surfaces of the first protrusion and the two second protrusions is about 300 micrometers.

12. The camera module of claim 7, wherein the lens module further comprises a flange protruding from the end surface, wherein the square substrate is surrounded by the flange.
